(19) United States
(12) Patent Application Publication
(10) Pub. No.: US 2023/0173310 A1
(43) Pub. Date: Jun. 8, 2023

(54) FACE MASK TO RESPIRATOR ADAPTER ASSEMBLY

(71) Applicant: Jinhai Yang, Hattiesburg, MS (US)

(72) Inventor: Jinhai Yang, Hattiesburg, MS (US)

(21) Appl. No.: 17/543,810

(22) Filed: Dec. 7, 2021

(51) Int. Cl. A62B 18/08; A41D 13/11

(52) U.S. Cl. CPC A62B 18/084; A41D 13/1107

(57) ABSTRACT

A face mask to respirator adapter assembly includes a cylinder which has a nose recess integrated into the cylinder. The nose recess accommodates a user’s nose when the cylinder is positioned beneath a face mask when the face mask is being worn. The device includes a cushion that extends around the cylinder and which abuts the user’s face when the cylinder is positioned beneath the face mask to enhance comfort for the user.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### Field of the Invention

The disclosure relates to adapter devices and more particularly pertains to a new adapter device for inhibiting a face mask from touching a user’s face when the face mask is being worn. The device includes a cylinder which has a nose recess integrated into the cylinder. The nose recess accommodates a user’s nose when the cylinder is positioned beneath a face mask when the face mask is being worn. The device includes a cushion that extends around the cylinder and which abuts the user’s face when the cylinder is positioned beneath the face mask to enhance comfort for the user.

### Description of Related Art Including Information Disclosed Under 37 CFR 1.97 And 1.98

The prior art relates to adapter devices including a respirator face mask that includes a pair of removable filtering canisters. The prior art discloses a face mask that includes an exhaust filter for removing odor from a user’s exhaled breath during hunting. The prior art discloses a face mask that includes an inhalation adapter that can be fluidly attached to a medication container. The prior art discloses a face mask which has an exhalation valve that is integrated into the face mask for passing exhaled air through the exhalation valve.

### BRIEF SUMMARY OF THE INVENTION

An embodiment of the disclosure meets the needs presented above by generally comprising a cylinder that is comprised of a rigid material. The cylinder is positionable beneath a face mask when the face mask is being worn. In this way the cylinder inhibits the face mask from touching a user’s face when the face mask is being worn. A cushion is coupled to the cylinder and the cushion abuts the user’s face when the cylinder is positioned between the face mask and the user’s face. Furthermore, the cushion is comprised of a resiliently compressible material to enhance comfort for the user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a face mask to respirator adapter assembly according to an embodiment of the disclosure.

FIG. 2 is a front view of an embodiment of the disclosure.

FIG. 3 is a back view of an embodiment of the disclosure.

FIG. 4 is a bottom view of an embodiment of the disclosure.

FIG. 5 is a top view of an embodiment of the disclosure.

FIG. 6 is a perspective in-use view of an embodiment of the disclosure.

FIG. 7 is a phantom in-use view of an embodiment of the disclosure.

FIG. 8 is a front perspective view of an alternative embodiment of the disclosure.

FIG. 9 is a cross sectional view taken along line 9-9 of FIG. 8 of an embodiment of the disclosure.

FIG. 10 is a perspective view of an alternative embodiment of the disclosure.

FIG. 11 is a cross sectional view taken along line 11-11 of FIG. 10 of an embodiment of the disclosure.

FIG. 12 is a perspective view of an alternative embodiment of the disclosure.

FIG. 13 is a perspective in-use view of an alternative embodiment of the disclosure.

### DETAILED DESCRIPTION OF THE INVENTION

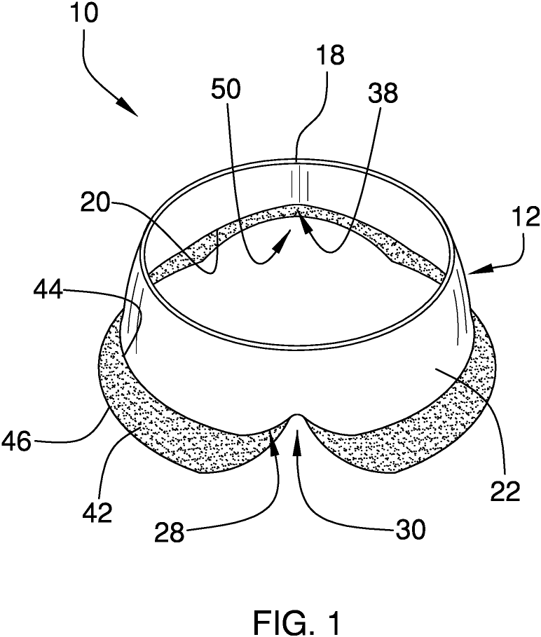

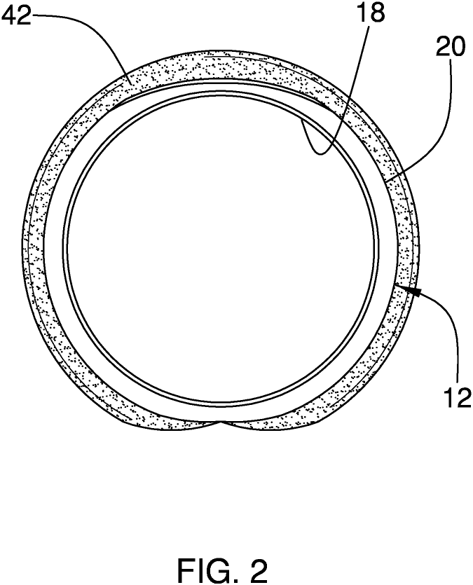

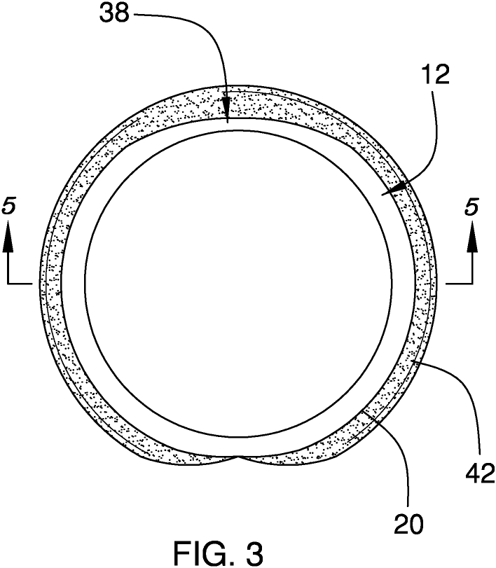

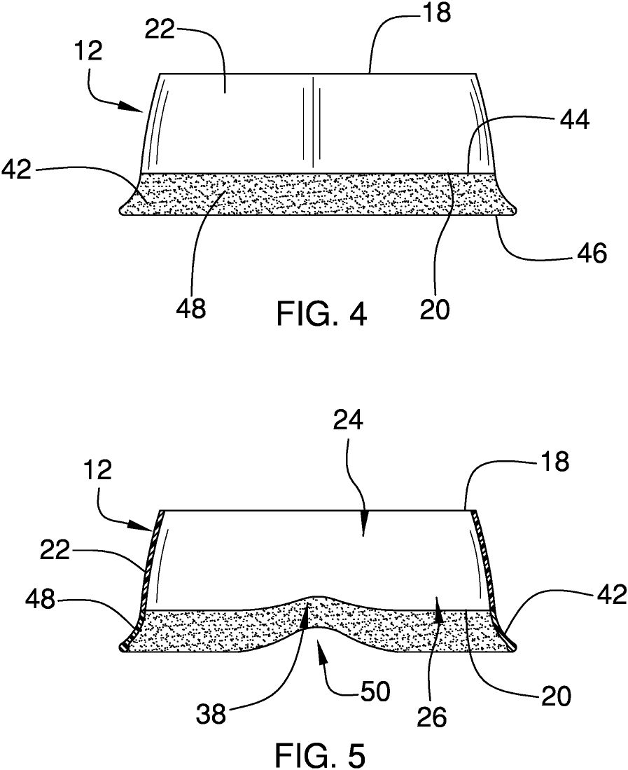

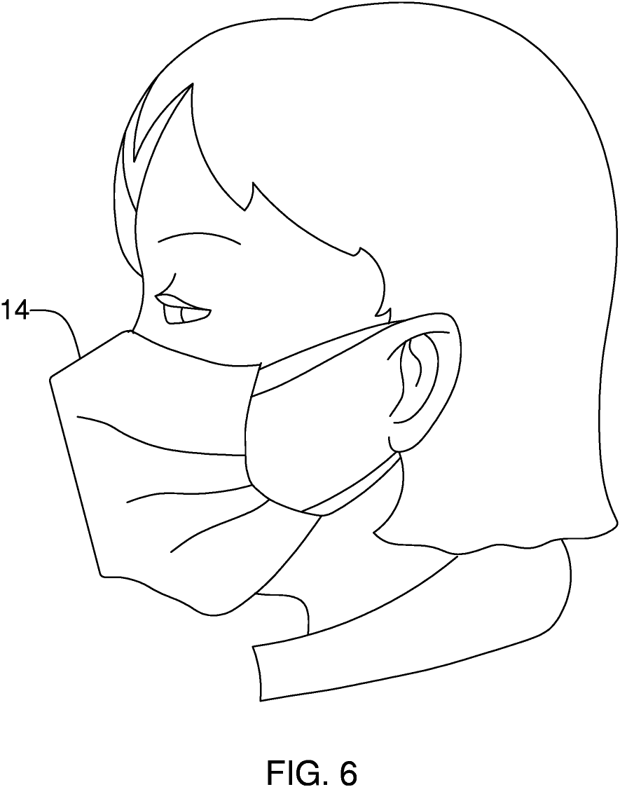

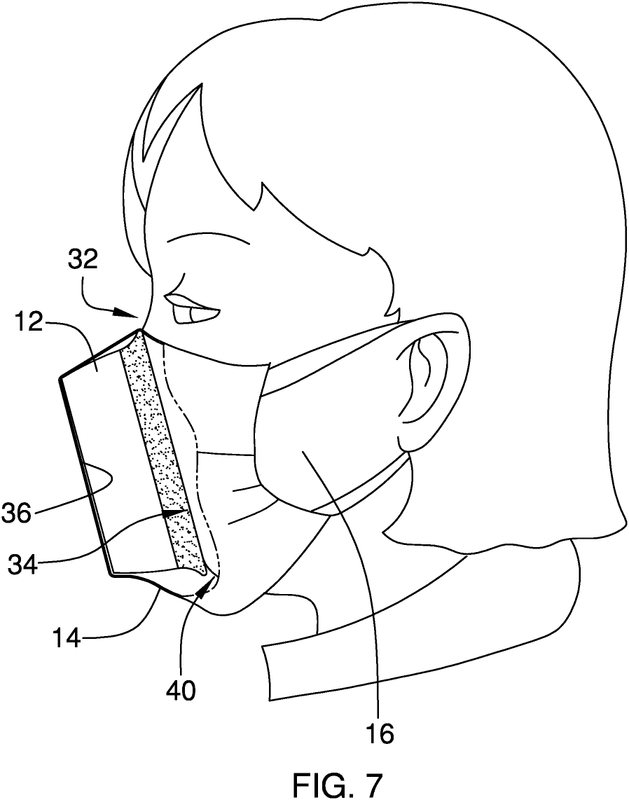

With reference now to the drawings, and in particular to FIGS. 1 through 13 thereof, a new adapter device embodying the principles and concepts of an embodiment of the disclosure and generally designated by the reference numeral 10 will be described.

As best illustrated in FIGS. 1 through 13, the face mask to respirator adapter assembly 10 generally comprises a cylinder 12 that is comprised of a rigid material, including but not being limited to, plastic, metal or other fluid impermeable material. The cylinder 12 is positionable beneath a face mask 14 when the face mask 14 is being worn. In this way the cylinder 12 inhibits the face mask 14 from touching a user’s face 16 when the face mask 14 is being worn. The face mask 14 may be a face mask that is approved for use for protection against the airborne transmission of infectious diseases or other similar type of face mask.

The cylinder 12 has a front edge 18, a back edge 20 and an outer wall 22 extending between the front edge 18 and the back edge 20. The outer wall 22 tapers inwardly between the back edge 20 and the front edge 18 such that the front edge 18 defines an opening 24 which has a diameter that is less than a diameter of an opening 26 defined by the back edge 20. The back edge 20 has a curved portion 28 extending toward the front edge 18 and the curved portion 28 defines a nose recess 30 to accommodate the user’s nose 32 when the cylinder 12 is worn beneath the face mask 14 such that the back edge 20 surrounding the user’s nose 32 and mouth 34. Additionally, the front edge 18 abuts a rear side 36 of the face mask 14 when the face mask 14 is worn. The back edge 20 has a chin portion 38 which curves toward the front edge 18 and the chin portion 38 is positioned on an opposite side of the cylinder 12 with respect to the nose recess 30. Moreover, the chin portion 38 accommodates the user’s chin 40 when the cylinder 12 is worn beneath the face mask 14.

A cushion 42 is coupled to the cylinder 12 and the cushion 42 abuts the user’s face 16 when the cylinder 12 is positioned between the face mask 14 and the user’s face 16. The cushion 42 is comprised of a resiliently compressible material to enhance comfort for the user. Additionally, the cushion 42 is comprised of a fluid impermeable material to inhibit air from passing between the cushion 42 and the user’s face 16 when the user breathes. The cushion 42 has a coupled edge 44, a free edge 46 and an exterior wall 48 extending between the coupled edge 44 and the free edge 46. Additionally, the exterior wall 48 flares outwardly between the coupled edge 44 and the free edge 46. An adhesive, such as adhesive tape, putty or other type of non toxic adhesive can be applied to the cushion 42 to enhance fitment to the user’s face 16.

The coupled edge 44 is coupled to the back edge 20 of the cylinder 12 and the coupled edge 44 extends around a substantial circumference of the back edge 20. The free edge 46 has a chin portion 50 which curves toward the coupled edge 44. The chin portion 50 of the free edge 46 is aligned with the chin portion 38 of the back edge 20 of the cylinder 12 such that the chin portion 50 of the free edge 46 conforms to the user’s chin 40 when the cylinder 12 is worn beneath the face mask 14. The free edge 46 joins the coupled edge 44 at opposing sides of the nose recess 30 defined by the curved portion 28 of the back edge 20 of the cylinder 12. In this way the cushion 42 terminates on each of the opposing sides of the nose recess 30 to accommodate the user’s nose 32 when the cylinder 12 is worn beneath the face mask 14.

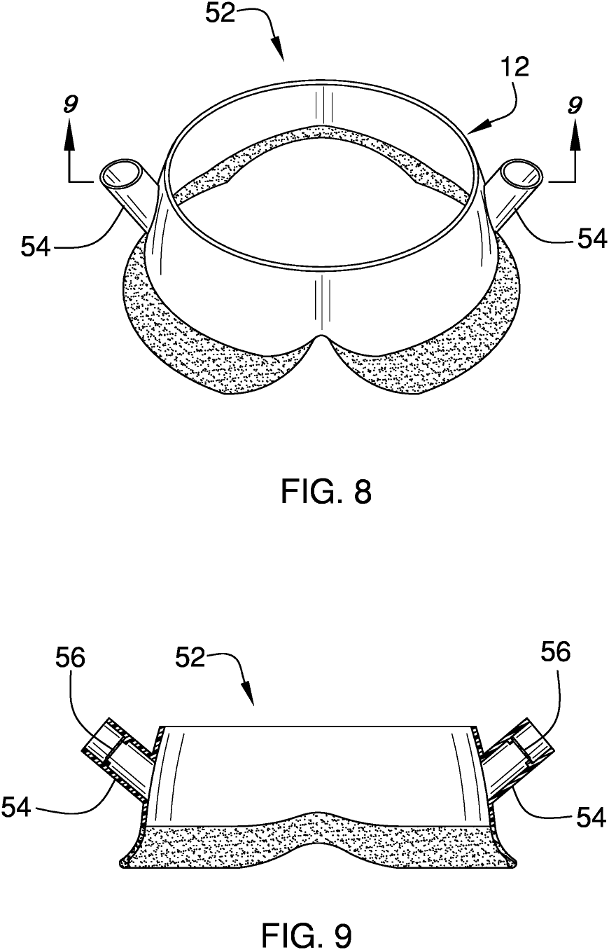

In an alternative embodiment 52 as is most clearly shown in FIGS. 8 and 9, a pair of exhale tubes 54 is each integrated into the outer wall 22 of the cylinder 12 to pass air through the exhale tubes 54 the when user exhales. Each of the exhale tubes 54 is positioned on opposite sides of the cylinder 12 with respect to each other and each of the exhale tubes 54 is oriented to angle toward the front edge 18 of the cylinder 12. Continuing in the alternative embodiment 52, a pair of check valves 56 is each integrated into a respective one of the exhale tubes 54. Each of the check valves 56 is in a normally closed position to inhibit air from passing through the respective exhale tube 54 and into the cylinder 12. Conversely, each of the check valves 56 is urgeable into an open position to facilitate air to pass from the cylinder 12 and outwardly through the respective exhale tube 54 when the user exhales.

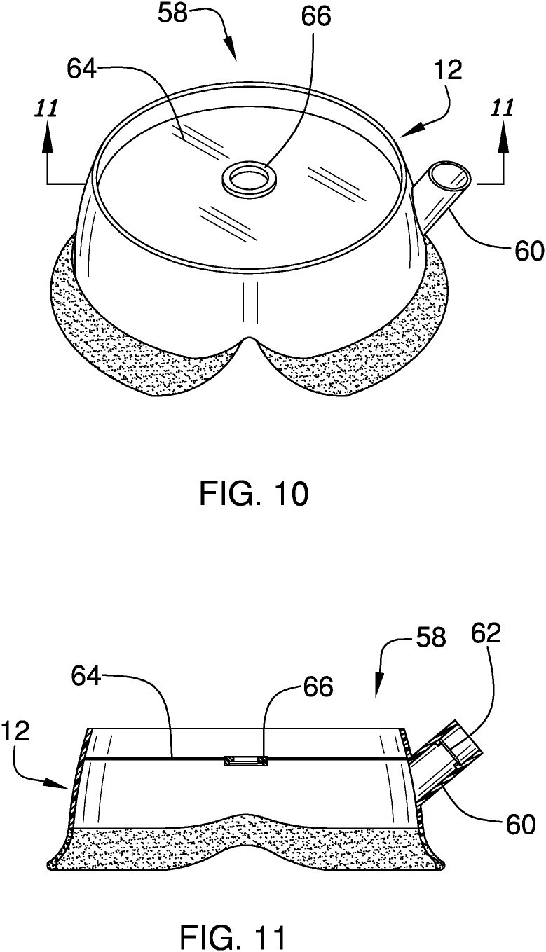

In alternative embodiment 58 as is most clearly shown in FIGS. 10 and 11, an exhale tube 60 is integrated into the outer wall 22 of the cylinder 12 to pass air through the exhale tube 60 the when user exhales. The exhale tube 60 is oriented to angle toward the front edge 18 of the cylinder 12. Continuing in the alternative embodiment 58, a check valve 62 is integrated into the exhale tube 60. The check valve 62 is in a normally closed position to inhibit air from passing through the exhale tube 60 and into the cylinder 12. Conversely, the check valve 62 is urgeable into an open position to facilitate air to pass from the cylinder 12 and outwardly through the exhale tube 60 when the user exhales.

Continuing in the alternative embodiment 58 as depicted in FIGS. 10 and 11, a membrane 64 is integrated into the cylinder 12 and the membrane is positioned between the front edge 18 and the back edge 20 such that the membrane 64 is positioned inside of the cylinder 12. The membrane 64 is comprised of a fluid permeable material to inhibit air from passing through the membrane 64. A check valve 66 is fluidly integrated into the membrane 64 and the check valve in the membrane 64 is in a normally closed position to inhibit air from passing through the check valve 66 in the membrane 64. Conversely, the check valve 66 in the membrane 64 is urgeable into an open position to facilitate air to pass through the check valve 66 in the membrane 64 in a flow of direction moving from the front edge 18 of the cylinder 12 toward the back edge 20 of the cylinder 12 when the user inhales. A pair of the check valves 66 may be provided, each with an opposing direction of flow such that a respective one of the check valves 66 facilitates exhaled air to pass through the respective pair of check valves 66 and a respective one of the check valves 66 facilitates inhaled air to pass through the respective pair of check valves 66.

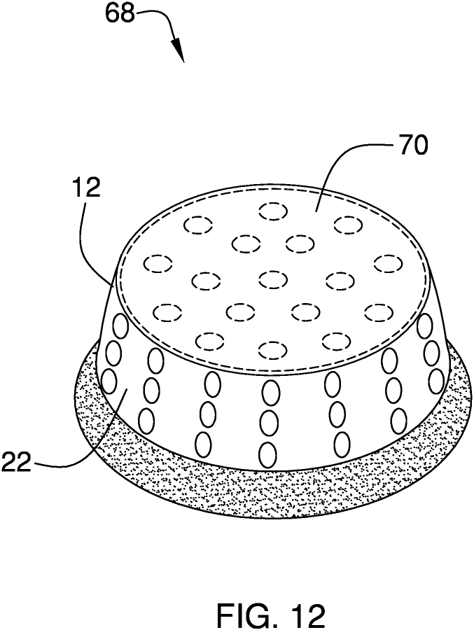

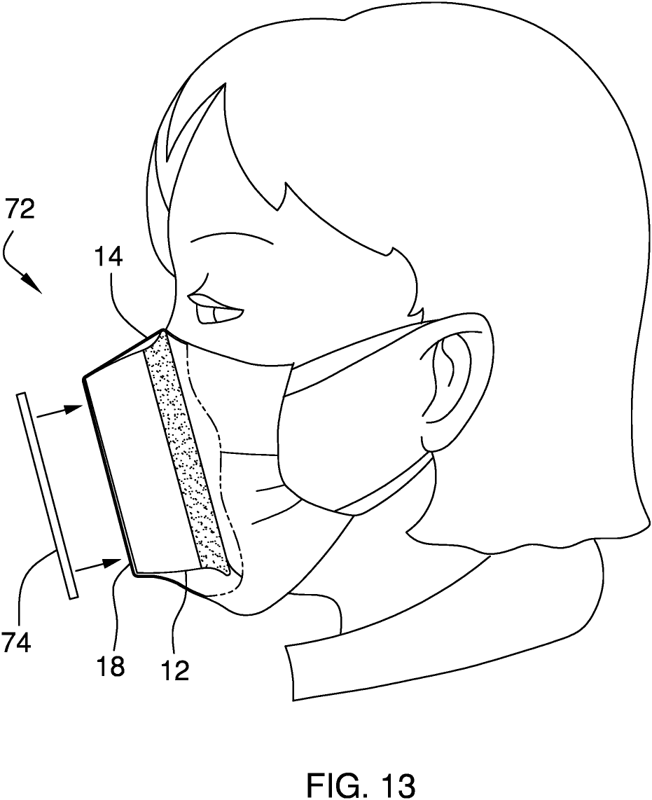

In an alternative embodiment 68 as is most clearly shown in FIG. 12, cylinder 12 may be foraminous such that air and heat can pass through the cylinder 12 and to facilitate the user’s voice to more clearly pass through the cylinder 12. A film barrier 70 may be integrated into the outer wall 22 of the cylinder 12 and which extends around a fill circumference of the outer wall 22. The film barrier 70 may be comprised of a fluid impermeable material to inhibit air from passing through the film barrier 70. In an alternative embodiment 72 as is most clearly shown in FIG. 13, a ring 74 is provided that is attachable face mask 14 to compress the face mask 14 against the front edge 18 of the cylinder 12. In this way the ring 74 inhibits air from passing between the face mask 14 and the front edge 18 of the cylinder 12. The ring 74 may be comprised of rubber, silicone or other type of deformable material, and the ring may have a diameter sufficient to conform to the cylinder 12.

In use, the cylinder 12 is worn beneath the face mask 14 when the user is wearing the face mask 14. The cylinder 12 is oriented such that the user’s nose 32 is positioned in the nose recess 30 and the user’s chin 40 is positioned in the chin portion 38. In this way the cylinder 12 inhibits the face mask 14 from contacting the user’s nose 32 and mouth 34 when the face mask 14 is being worn. Additionally, the cushion 42 inhibits air from passing between the user’s face 16 and the cushion 42 when the user breathes. In this way the cylinder 12 ensures that the air that the user breathes passes through the face mask 14 such that the face mask 14 filters the air being breathed with maximum efficiency.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A face mask to respirator adapter assembly for wearing beneath a face mask for improving the fit of the face mask, said assembly comprising:
a cylinder being comprised of a rigid material, said cylinder being positionable beneath a face mask when the face mask is being worn wherein said cylinder is configured to inhibit the face mask from touching a user’s face when the face mask is being worn; and
a cushion being coupled to said cylinder wherein said cushion is configured to abut the user’s face when said cylinder is positioned between the face mask and the user’s face, said cushion being comprised of a resiliently compressible material wherein said cushion is configured to enhance comfort for the user.

2. The assembly according to claim 1, wherein:
said cylinder has a front edge, a back edge and an outer wall extending between said front edge and said back edge, said outer wall tapering inwardly between said back edge and said front edge such that said front edge defines an opening having a diameter being less than a diameter of an opening defined by said back edge; and
said back edge has a curved portion extending toward said front edge such that said curved portion defines a nose recess wherein said nose recess is configured to accommodate the user’s nose when said cylinder is worn beneath the face mask having said back edge surrounding the user’s nose and mouth, said front edge abutting a rear side of the face mask when the face mask is worn.

3. The assembly according to claim 2, wherein said cushion has a coupled edge, a free edge and an exterior wall extending between said coupled edge and said free edge, said exterior wall flaring outwardly between said coupled edge and said free edge, said coupled edge being coupled to said back edge of said cylinder, said coupled edge extending around a substantial circumference of said back edge.

4. The assembly according to claim 3, wherein:
said back edge of said cylinder has a chin portion curving toward said front edge of said cylinder, said chin portion being positioned on an opposite side of said cylinder with respect to said nose recess wherein said chin portion is configured to accommodate the user’s chin when said cylinder is worn beneath the face mask; and
said free edge of said cushion has a chin portion curving toward said coupled edge of said cushion, said chin portion of said free edge being aligned with said chin portion of said back edge of said cylinder wherein said chin portion of said free edge is configured to conform to the user’s chin when said cylinder is worn beneath the face mask.

5. The assembly according to claim 3, wherein said free edge joins said coupled edge at opposing sides of said of said nose recess defined by said curved portion of said back edge of said cylinder such that said cushion terminates on each of said opposing sides of said nose recess wherein said cushion is configured to accommodate the user’s nose when said cylinder is worn beneath the face mask.

6. A face mask to respirator adapter assembly for wearing beneath a face mask for improving the fit of the face mask, said assembly comprising:
a cylinder being comprised of a rigid material, said cylinder being positionable beneath a face mask when the face mask is being worn wherein said cylinder is configured to inhibit the face mask from touching a user’s face when the face mask is being worn, said cylinder having a front edge, a back edge and an outer wall extending between said front edge and said back edge, said outer wall tapering inwardly between said back edge and said front edge such that said front edge defines an opening having a diameter being less than a diameter of an opening defined by said back edge, said back edge having a curved portion extending toward said front edge such that said curved portion defines a nose recess wherein said nose recess is configured to accommodate the user’s nose when said cylinder is worn beneath the face mask having said back edge surrounding the user’s nose and mouth, said front edge abutting a rear side of the face mask when the face mask is worn, said back edge having a chin portion curving toward said front edge, said chin portion being positioned on an opposite side of said cylinder with respect to said nose recess wherein said chin portion is configured to accommodate the user’s chin when said cylinder is worn beneath the face mask; and
a cushion being coupled to said cylinder wherein said cushion is configured to abut the user’s face when said cylinder is positioned between the face mask and the user’s face, said cushion being comprised of a resiliently compressible material wherein said cushion is configured to enhance comfort for the user, said cushion having a coupled edge, a free edge and an exterior wall extending between said coupled edge and said free edge, said exterior wall flaring outwardly between said coupled edge and said free edge, said coupled edge being coupled to said back edge of said cylinder, said coupled edge extending around a substantial circumference of said back edge, said free edge having a chin portion curving toward said coupled edge, said chin portion of said free edge being aligned with said chin portion of said back edge of said cylinder wherein said chin portion of said free edge is configured to conform to the user’s chin when said cylinder is worn beneath the face mask, said free edge joining said coupled edge at opposing sides of said of said nose recess defined by said curved portion of said back edge of said cylinder such that said cushion terminates on each of said opposing sides of said nose recess wherein said cushion is configured to accommodate the user’s nose when said cylinder is worn beneath the face mask.

7. The assembly according to claim 6, further comprising a pair of exhale tubes, each of said exhale tubes being integrated into said outer wall of said cylinder wherein each of said exhale tubes is configured to pass air through said exhale tubes the when user exhales, each of said exhale tubes being positioned on opposite sides of said cylinder with respect to each other, each of said exhale tubes being oriented to angle toward said front edge of said cylinder.

8. The assembly according to claim 7, further comprising a pair of check valves, each of said check valves being integrated into a respective one of said exhale tubes, each of said check valve being in a normally closed position wherein each of said check valves is configured to inhibit air from passing through said respective exhale tube and into said cylinder, each of said check valves being urgeable into an open position wherein each of said check valves is configured to facilitate air to pass from said cylinder and outwardly through said respective exhale tube when the user exhales.

9. The assembly according to claim 7, further comprising an exhale tube being integrated into said outer wall of said cylinder wherein said exhale tube is configured to pass air through said exhale tube the when user exhales, said exhale tube being oriented to angle toward said front edge of said cylinder.

10. The assembly according to claim 9, further comprising a check valve being integrated into said exhale tube, said check valve being in a normally closed position wherein said check valve is configured to inhibit air from passing through said exhale tube and into said cylinder, said check valve being urgeable into an open position wherein said check valve is configured to facilitate air to pass from said cylinder and outwardly through said exhale tube when the user exhales.

11. The assembly according to claim 7, further comprising a membrane being integrated into said cylinder, said membrane being positioned between said front edge and said back edge such that said membrane is positioned inside of said cylinder, said membrane being comprised of a fluid permeable material wherein said membrane is configured to inhibit air from passing through said membrane.

12. The assembly according to claim 11, further comprising a check valve being fluidly integrated into said membrane, said check valve being in a normally closed position wherein said check valve is configured to inhibit air from passing through said check valve, said check valve being urgeable into an open position wherein said check valve is configured to facilitate air to pass through said check valve in a flow of direction moving from said front edge of said cylinder toward said back edge of said cylinder when the user inhales.
